(19) United States
(12) Patent Application Publication
(10) Pub. No.: US 2011/0211683 A1
(43) Pub. Date: Sep. 1, 2011

(54) Method and device by telephone entry systems

(76) Inventors: Anders Edvard Trell, Stockholm (SE); Shrikant Chandrakant Pathak, Pune (IN)

(21) Appl. No.: 12/927,724

(22) Filed: Nov. 23, 2010

Related U.S. Application Data
(60) Provisional application No. 61/335,062, filed on Dec. 31, 2009.

(51) Int. Cl. H04M 9/00

(52) U.S. Cl. 379/167.11

(57) ABSTRACT

A method and a device complementing a normally preinstalled telephone entry system with option for certain residents to open an entrance door by calling and presenting their telephone numbers/addresses. Advantageously, the telephone entry system's already existing tele connection, subscription, telephone number/address and possible answering are employed for the functioning.

The present invention claims priority from U.S. provisional Application 61/335,062, filed Dec. 31, 2009 and of same title.

### FIELD OF THE INVENTION

The present invention relates to entrance intercom systems, and more particularly, to improvements by already installed telephone entry systems.

### BACKGROUND OF THE INVENTION

Entry telephones such as e.g. U.S. Pat. No. 3,947,641, so called tele(phone) is entry systems, hereinafter referred to as “tele-intercom(s)”, have become popular and widespread, but over the years certain disadvantages have developed. With “opening” fees, higher call fees and increased use of (costlier to call) mobile telephones, their running costs for estates having them installed have sharply increased, leading to the introduction of so called “no telephone bill” systems, very expensive to install, though. Also “hybrids” such as U.S. Pat. No. 5,046,083 have emerged to help reducing running costs, but they too are quite expensive. Thus, most estates having installed tele-intercoms, stick to them, maybe trying to economize by deleting mobile numbers from them or separately bill for numbers dialed, but these and other so far available measures remain mostly compromises. At same time, one naturally wants to justify already made investments in a basically well functioning installation, good entrance design etc. There is so all reason and room for improvement making good and adequate use of a preexisting installation.

Through WO 2005/104516 is known how CLIP (Calling Line Identity presentation; herein-below, “CLIP” also stands for numerical information arriving at a call) generally can be used for i. a. entry communication/opening; also in one proposed embodiment at manufacture integrating a common tele-intercom therewith. Such a latter system must be wholly installed, requires its own individual telephone connection, subscription etc., is rather expensive and the outgoing tele-intercom calls will cost as usual. It can not also solve the problems of already installed tele-intercoms, other than by totally replace them, which is a waste of resources already installed and paid for. A similarly comprehensive and integrated system is presently marketed in Sweden under the name of PA-57 PROX.

### SUMMARY OF THE INVENTION

It is an objective of the present invention to provide a cost effective and advantageous device for solving the above related problems. In doing so, it makes use of CLIP and takes into account due factors of already installed tele-intercoms. Since these already are installed, telephone or data network (PSTN, Public Switched Telephone Network) connection, subscription etc. fees and costs are already paid and thus attachment and connection of a unit (1) direct to their actual telecommunication line will be gratis.

They have already all needed entrance infrastructure, such as (electrical) lock (7),a tele connection (2) (albeit mostly without CLIP-service) to which they are end-of-line connected; and also they have a telephone number/address (hereinafter “[telephone] number”), can thus be called and almost all nowadays for remote programming purposes will reply to a call.

The present invention makes measured use of these factors for reducing the running operating costs for installed tele-intercoms, to a user programmable extent, and in a single installation of a—since specifically designed for this and only purpose and employment—simple, effective and low-cost device.

### BRIEF DESCRIPTION OF THE DRAWINGS

The invention can be more fully understood by reading the following detailed description of a preferred embodiment, with reference to the accompanying drawings, wherein:

FIG. 1 is a schematic view, showing the structure of a first embodiment.

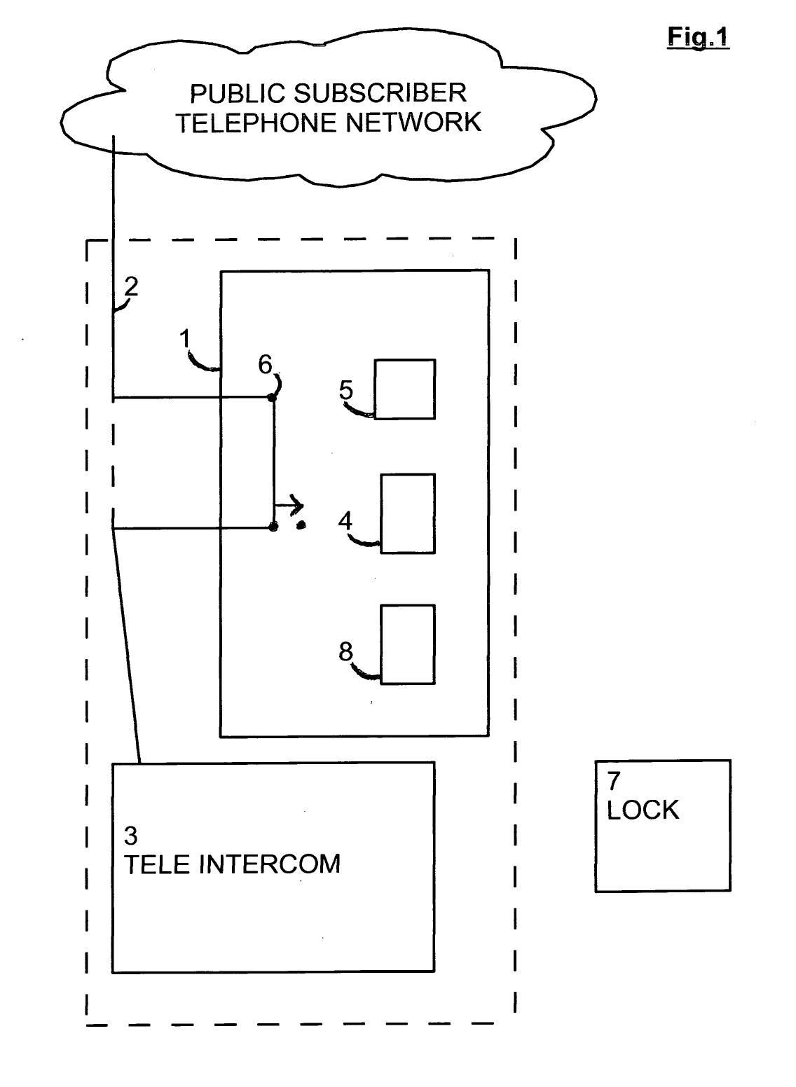

FIG. 2 is a schematic view, showing the structure of a second embodiment.

### DETAILED DESCRIPTION OF THE PREFERRED EMBODIMENTS

A regular telephone/IP/data/LAN wired line, 2, is coming in from the PSTN, terminating in an already installed tele-intercom system unit, 3, which is entirely conventional. Thus it already has a subscription and a telephone number; and can be called by parties knowing that number, even if it may not be enabled to answer a call. For the basic functioning of the present invention this is not needed, but it must be ascertained that a caller-ID service is ordered and/or provided to the subscription, number and/or line 2.

A first preferred embodiment of the present invention works as follows: The performing unit itself, 1, is organized around a common CLIP contrivance, 4, which in its turn is associated with a common user programmable (micro)computer, 5, with usual needed support, in/output etc. circuits; and primarily controlling a relay 6, after installation of 1 intercepting line 2 at a suited point between unit 3 and PSTN. Since conventional, all that won't be deeper described.

Programmed with telephone numbers of participating residents, 1 will perform thus that it will read all telephone numbers that arrive on the ring signal of an incoming call (to the already existing telephone number of the tele-intercom). Seeing a programmed (resident) number, the normally closed 6 is ordered to break, which action also can bring 1 into further action, such as in this basic embodiment open an already existing lock 7.

This will have the advantageous effect on a unit 3 installation that certain cumbersome or expensive numbers to call can, likely in administrative cooperation with, but else independently of unit 3, be deleted from 3 and instead being programmed into 1. Thus these numbers (residents) must be called by a is visitor by using an own calling means. When the thus called resident in its turn calls 3 (knowing its number), 1 will see an approved number and open the common lock. Thus costs, features etc. can be administered, time zoned etc. and for the rest, the old 3 installation will work as before, but now at controllable costs.

A few hurdles exist though, with this basic first embodiment. With virtually the same advantageous end result, more capable and advantageous preferred embodiments of it will be introduced and below nearer described.

Firstly, as stated above, most tele-intercoms will today (for e.g. remote programming) answer a call. Secondly, the caller-ID format FSK/“Bell-core” arrives on the ring, which is a fairly aggressive >100 Volt AC from which electronic circuits should be isolated. The first embodiment thus needs practical modification in order to work properly.

A common caller-ID implement reads the CLIP, isolated from the ring AC. Thus relay 6 can at once on ring break; and only after it has been ascertained that a ring doesn't contain a programmed number, make connection to 3 so that ensuing ring signals will reach 3, so it can answer for possible programming etc. (To avoid prank calls, numbers not authorized to program etc. 3 may be stopped.)

If the ring signal contains a programmed number however, lock 7 can be ordered to open, while relay 6 still keeps line 2 to 3 broken, so that 3 can't answer, since if so, the caller (resident) will unintentionally be debited a call fee.

Esp. mobile phone numbers are, due to so called spoofing or theft etc., more insecure than fix (wired) numbers which are very secure as CLIP:s. It can thus be desired to safeguard such more insecure number further, e.g. by complementing them with a by the caller manually inputted code, e.g. by DTMF.

In order for any such code to be read by 1, the call must be answered. Circuits for such are quite complex and expensive, though, and would make unit 1 much more expensive if to be included therein (even if such a version is possible and included in the present inventive thought). It is however here realized by the present invention that an answering capability of 3 could be advantageously used.

When unit 1 sees an incoming call number that is programmed as needing a complementary code for effectuation, it will as a first measure by means of relay 6 make the line 2 to tele-intercom unit 3 so that the latter can answer the call. In doing so, ringing will cease and a telephone connection is established over which e. g. a DTMF code can travel, and which can be read by the still hanging on 1. If a correct code shortly follows, access, e.g. lock release, can be effectuated. For this, unit 1 is equipped with a code, e.g. DTMF, re(or trans)ceiver 8. (It may also need a separate lock relay and a few other standard parts, not shown). The term relay herein used, stands for any device performing hard or soft switching.

This will not affect 3 since it will answer any call that reaches it, just going into programming at certain arriving number, mastercode etc., and not responding to other DTMF codes. The caller will be debited a call, but now this is intentional.

After access effectuation, the whole system will go back to idle and unit 3 is free for its normal use (relay 6 closed). Any activity from its side, such as DTMF dialing will not affect unit 1, since no incoming ring has preceded.

The callers (residents) themselves can aid smooth and/or wanted operation by varying the call up time. For instance and certain CLIP:s, direct opening may be effectuated by hanging up after one ring signal, whereas other actions, like having the unit 1 answer the call, may call for more.

Since processing time for esp. direct CLIP opening is very short, the accessibility of unit 3 is not much disturbed, and also, the latter's entrance calls are normally time limited. If either is on, the other will emit a busy signal, and re-try can be made after a while. If however the service caller-ID type 2 (“call waiting ID”) is subscribed to, direct unit 1 opening can be effectuated even if unit 3 is in a call.

Programming of unit 1 can be conventionally done at site or remotely by a call having a therefore authorized number; and unit 3 answering the call.

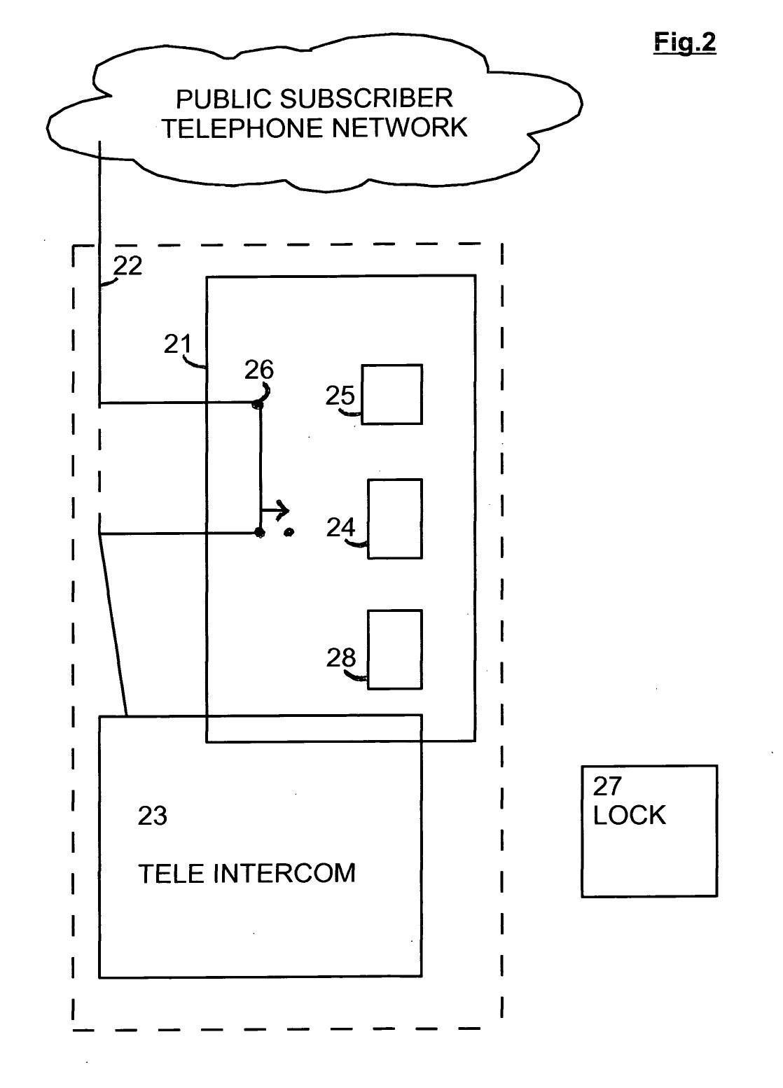

The device 1 can be tendered in an own casing (and installed beyond vandals', bad weather's etc. reach), but also as a pc-card or the like for placing at some vacant place within a tele-intercom's 3 casing, while still keeping its position on the line 2, mean functioning etc. intact. Such a placement is indicated in FIG. 2, and has the further advantage that certain discrete components of unit 3, like lock, lock relay, power supply etc. can be shared; and installation is also made easier.

A simple and low-cost, yet useful and capable device has been herein disclosed, which can mean good savings for many estates and their residents. The telephone companies can retain good business, by debiting users and not estates for telephone calls, and, in addition, estates for the annual subscription fees.

Thus also herewith a useful, new and advantageous business method has been invented and duly disclosed. The present invented method and device certainly may be varied here and there in steps and construction by one with ordinary skill in the art without functionally coming out of its operativeness as herein disclosed, described and discussed; and they both are meant covered by the following claims.

1. A method for use with an installed and lock-controlling telephone entry system, “tele-intercom” (3/23), said method comprising the steps of:
intercepting the wired telecommunication line (2/22) of said tele-intercom at a suitable point between said tele-intercom and a PSTN by connecting to said point a lock (7/27) controlling device (1/21) capable of making or breaking said line's path into said tele-intercom and of reading, processing and reacting to at least one CLIP arriving on said line;
into said device programming numerical information of said at least one CLIP and how to process and react to it after reading it; and
after found correspondence between said information and said at least one CLIP reacting in one or both of initiating opening of said lock and breaking or making said line's path into said tele-intercom.

2. A device (1/21) for use with an installed telephone entry system, “tele-intercom” (3/23), comprising:
a connecting means (6/26) for making or braking a telecommunication line (2/22) entering said tele-intercom;
a CLIP means (4/24) for reading, processing and reacting to at least one CLIP arriving on said telecommunication line;
a programmable computing means (5/25) for programming into said device numerical information of said at least one CLIP and how to processing and reacting to it after reading it; and
a lock means (7/27), under control of said device and opened as a result of one said reacting.

3. Device of claim 2 further comprising, a code reading means (8/28) for reading and reacting to certain codes arriving over an answered telephone call.

4. Device of claim 2 further comprising means for reacting differently to different periods that an arriving ring is allowed to go on.

5. Device of claim 3 wherein said reacting is lock opening.

6. Device of claim 4 wherein said reacting is lock opening.
